(19) United States
(12) Patent Application Publication
(10) Pub. No.: US 2026/0359806 A1
(43) Pub. Date: Nov. 12, 2026

(54) SECURE CONTACTLESS CARD

(71) Applicant: Cardtronics USA, Inc., Atlanta, GA (US)

(72) Inventor: Simon Paul Balfour, Kirkcaldy (GB)

(21) Appl. No.: 19/204,830

(22) Filed: May 12, 2025

(51) Int. Cl. G06Q 20/34; G06K 19/073; G06K 19/077

(52) U.S. Cl. CPC G06Q 20/354; G06K 19/07345; G06K 19/07749; G06Q 20/352

(57) ABSTRACT

A contactless payment card system implements selective activation control through a system on chip (SoC) architecture. The SoC includes a microcontroller executing firmware and an antenna interface coupled to an antenna circuit. Multiple selective activation mechanisms maintain the antenna circuit in a disabled state by default. In one implementation, an integrated switch creates an open circuit that can be temporarily bridged through user-applied pressure. Alternative implementations include a removable conductive key that completes the circuit when inserted, or firmware-controlled activation via a capacitive touch sensor that enables data transmission for a predetermined time period. The antenna interface controls data transmission capabilities, allowing card data to be wirelessly transmitted to a card reader only when user activation completes the antenna circuit. The system provides hardware and software-based security controls that prevent unauthorized contactless transactions.

### BACKGROUND

Contactless payment cards have become increasingly prevalent in modern transactions, offering convenience through their ability to complete payments without physical contact with payment terminals. However, this always-active contactless functionality creates security vulnerabilities since the cards can be activated and read without the cardholder's knowledge or consent. Unauthorized individuals may exploit this vulnerability by using card readers to initiate transactions when cards are stored in wallets, purses, or pockets, potentially leading to fraudulent charges and financial losses for cardholders. Current contactless payment cards lack built-in security measures that would allow cardholders to control when their cards are capable of completing contactless transactions.

### BRIEF DESCRIPTION OF THE DRAWINGS

FIG. 1 is a diagram of a secure contactless card, according to an example embodiment.

FIG. 2 is diagram of a secure contactless card with a user-controlled activation key, according to an example embodiment.

FIG. 3 is diagram of a secure contactless card with another user-controlled activation key, according to an example embodiment.

FIG. 4 is a diagram of a secure contactless card with yet another user-controlled activation key, according to an example embodiment.

FIG. 5 is a diagram of a secure contactless card with a user-controlled activation element, according to an example embodiment.

FIG. 6 is a diagram of a system for user-controlled and user-activated contactless card reading during a transaction with a card reader, according to an example embodiment.

FIG. 7 is a flow diagram of a method of operating a secure contactless card, according to an example embodiment.

### DETAILED DESCRIPTION

Contactless payment cards utilize embedded System on Chip (SoC) architectures to enable wireless transactions without physical contact between the card and payment terminal. The SoC contains a microcontroller and antenna interface that facilitate data transmission through an antenna circuit when energized by payment terminals. However, the default always-active state of these SoC components presents significant security vulnerabilities, as the embedded chips remain susceptible to unauthorized activation whenever within range of any compatible card reader.

The core technical challenge stems from the SoC's inability to control its activation state in conventional implementations. When cards are stored in wallets, purses, or pockets, the perpetually active antenna circuit allows unauthorized individuals to energize the SoC using concealed card readers, potentially enabling unauthorized data transmission and fraudulent transactions without the cardholder's knowledge. The lack of integrated hardware or firmware-based activation controls creates an inherent security vulnerability in existing contactless payment systems.

The disclosed technology addresses these vulnerabilities through selective activation controls integrated with the SoC architecture. A thin inline switch incorporated into the antenna circuit creates a default open state that physically prevents the SoC from being energized by external readers. The switch can be temporarily closed through user-initiated actions, providing hardware-level control over when the SoC can transmit card data.

Multiple implementations of the selective activation control are possible through the SoC architecture. In one embodiment, a low-profile switch integrated within the card structure maintains the antenna circuit in an open state by default. When a cardholder initiates a transaction, applying pressure to designated edges closes the circuit, allowing the SoC to transmit data. Alternative embodiments utilize a removable conductive key that, when extracted, creates a permanent circuit break until deliberately restored.

The SoC architecture also enables firmware-based activation control through a capacitive touch sensor interface. The firmware, executed by the SoC's microcontroller, monitors the sensor for user input and controls the antenna interface accordingly. When activated, the firmware enables data transmission for a predetermined period before automatically returning to a disabled state, providing a software-controlled security layer.

The firmware implementation stores activation logic in non-volatile memory or non-transitory computer-readable storage medium of the card, executed by the SoC's microcontroller to control the antenna interface. Upon detecting user input through the capacitive touch sensor, the firmware transitions the card from a non-data transmitting state to a data transmitting state and initiates a timer. When the configured time period expires, the firmware automatically disables data transmission capabilities.

The SoC architecture provides a unified platform for implementing these security controls. The microcontroller executes the firmware while managing the antenna interface that controls the card's data transmission capabilities. This integrated approach allows the selective activation controls to directly regulate the SoC's ability to respond to external card readers, effectively preventing unauthorized transactions.

The antenna interface 140 serves as an intermediary between the SoC 110 and the antenna circuit 150, controlling when and how card data is transmitted. When the antenna circuit is completed through any of the selective activation controls, the antenna interface 140 enables secure transmission of card data stored within the SoC 110 to a card reader during a transaction.

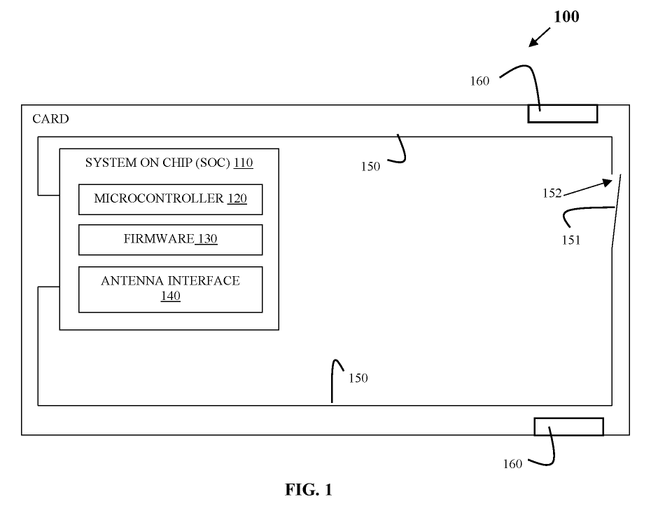

FIG. 1 is a diagram of a secure contactless card 100, according to an example embodiment. Notably, the components are shown schematically in simplified form, with only those components relevant to understanding of the embodiments being illustrated.

Furthermore, the various components (that are identified in card 100) are illustrated and the arrangement of the components are presented for purposes of illustration only. Notably, other arrangements with more or less components are possible without departing from the teachings of secure contactless card activation, presented herein and below.

FIG. 1 illustrates a secure contactless card 100 that includes a system on chip (SoC) 110, a microcontroller 120, firmware 130, and an antenna interface 140 coupled to an antenna circuit 150. The antenna circuit 150 includes a broken portion 151 that creates a gap 152. Contact portions 160 are positioned on opposite sides of gap 152. When a user applies pressure to the contact portions 160, the gap 152 is bridged, moving the broken portion back into alignment and completing the antenna circuit 150 and enabling card data transmission.

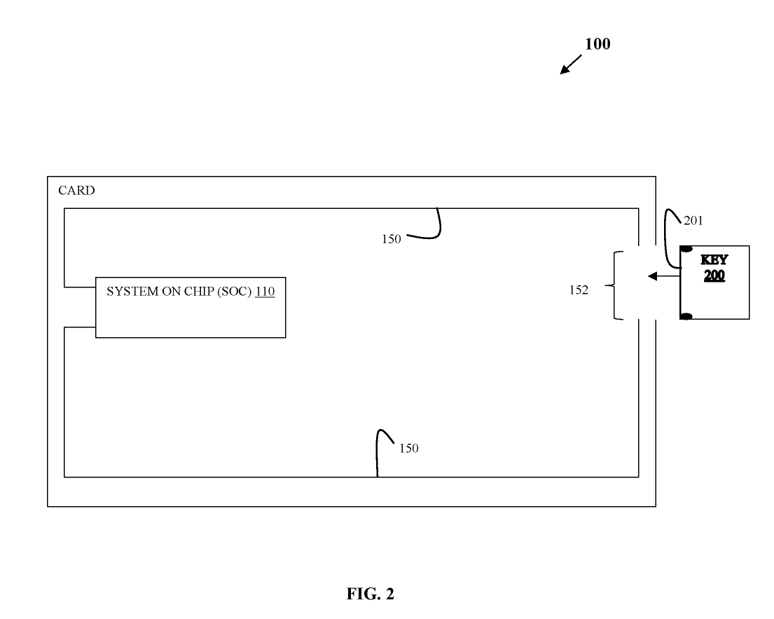

FIG. 2 is diagram of a secure contactless card 100 with a user-controlled activation key 200, according to an example embodiment. Again, the components are shown schematically in simplified form, with only those components relevant to understanding of the embodiments being illustrated.

FIG. 2 depicts the contactless card 100 with a selective activation control comprising a removable key 200. The key 200 includes a conductive portion 201 that is configured to be inserted into gap 152 of antenna circuit 150 to complete the circuit. When the key 200 is removed, the antenna circuit 150 remains in a disabled state by default, preventing unauthorized card data transmission.

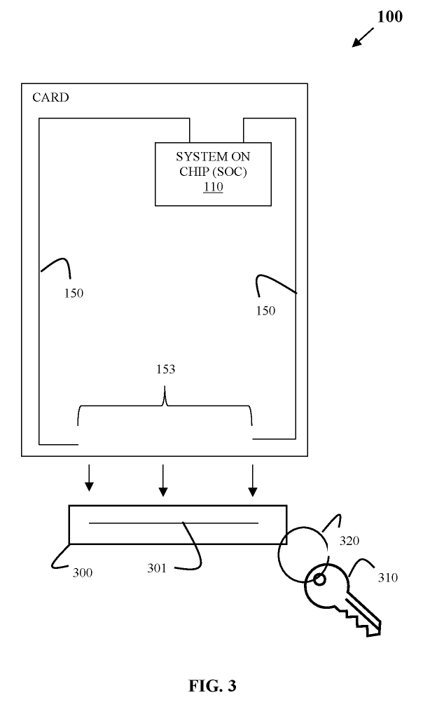

FIG. 3 is diagram of a secure contactless card 100 with another user-controlled activation key 300, according to an example embodiment. The components are shown schematically in simplified form, with only those components relevant to understanding of the embodiments being illustrated.

FIG. 3 shows the contactless card 100 with an alternative selective activation control comprising a removable key base 300. The key base 300 includes a conductive portion 310 and is adapted to fit over a side of card 100 to complete the antenna circuit across gap 152. The key base 300 is configured to be stored on a keyring 320 along with key 301, providing convenient access when card activation is desired. The conductive portion 301 and base 300 form a removable key base.

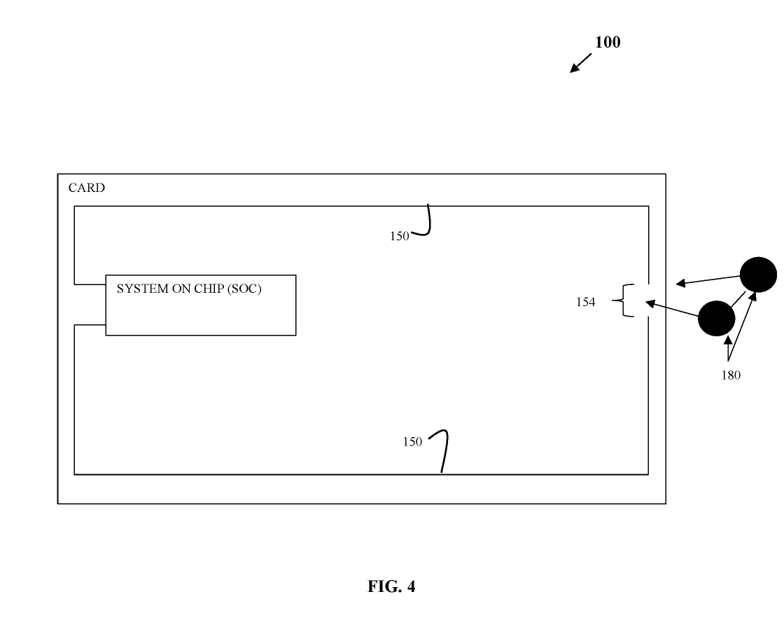

FIG. 4 is a diagram of a secure contactless card 100 with yet another user-controlled activation key 400, according to an example embodiment. Notably, the components are shown schematically in simplified form, with only those components relevant to understanding the embodiments illustrated.

FIG. 4 illustrates the contactless card 100 manufactured with an open antenna circuit having gap 154. The selective activation control comprises conductive fobs 180 configured to be placed on opposite sides of the card surface over gap 154 in antenna 150 to complete the antenna circuit.

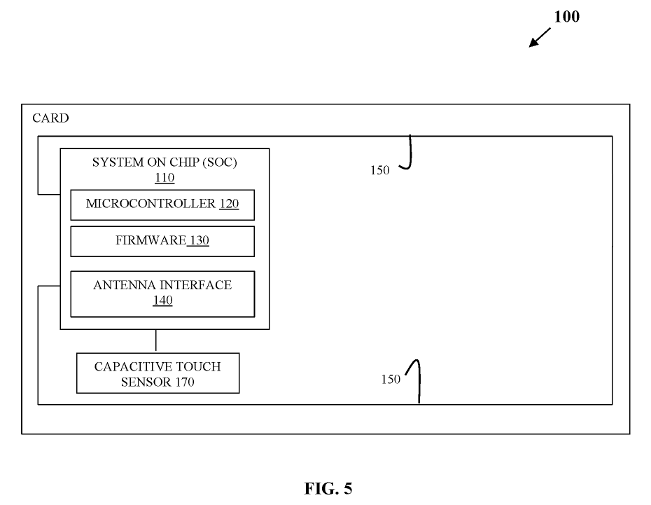

FIG. 5 is a diagram of a secure contactless card 100 with a user-controlled activation element 170, according to an example embodiment. The components are shown schematically in simplified form, with only those components relevant to understanding the embodiments illustrated.

FIG. 5 shows the contactless card 100 incorporating a capacitive touch sensor 170 coupled to the SoC 110. When a user touches sensor 170, firmware 130 executed by microcontroller 120 enables the antenna interface 140 to wirelessly transmit card data stored on card 100 via antenna 150. The firmware 130 maintains a timer, and when the predetermined time period expires, the firmware 130 automatically disables card data transmission, returning the card to a non-data transmitting state.

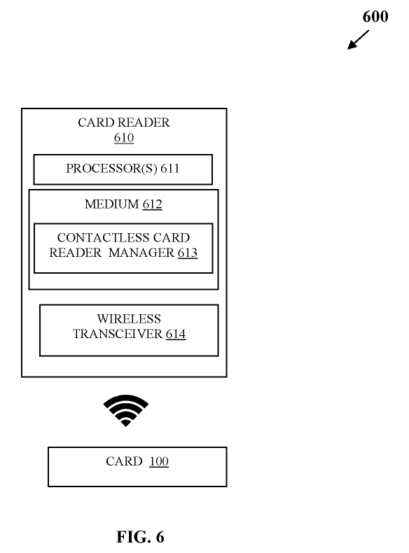

FIG. 6 is a diagram of a system 600 for user-controlled and user-activated contactless card reading during a transaction with a card reader, according to an example embodiment. Notably, the components are shown schematically in simplified form, with only those components relevant to understanding the embodiments illustrated.

FIG. 6 depicts a payment system including the contactless card 100 and a contactless card reader 610. The card reader 610 includes a contactless card reader manager 613 and a wireless transceiver 614. During a payment transaction, the wireless transceiver 614 is configured to receive card data wirelessly transmitted from the contactless card 100 when the card's selective activation control has enabled the antenna circuit. The selective activation control can be achieved in any of the manners illustrated in FIGS. 1-5.

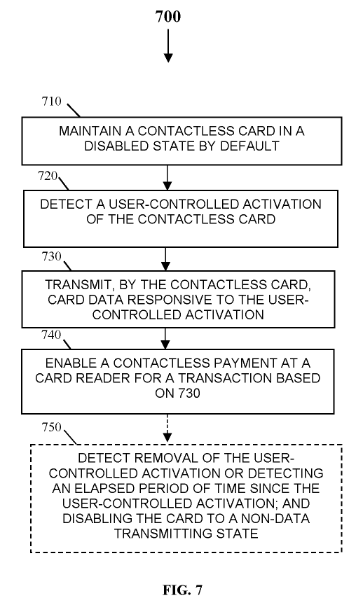

FIG. 7 is a flow diagram of a method 700 of operating a secure contactless card, according to an example embodiment. The method 700 is executed by a microcontroller 120 of a contactless card 100. In an embodiment, the instructions executed by the microcontroller 120 are firmware 130.

At 710, firmware 130 maintains a contactless card 100 in a disabled state by default. This can be done in any of the manners discussed above with FIGS. 1-6.

At 720, the firmware 130 detects a user-controlled activation of the contactless card 100. For example, the user pinches contact portions 160 on the card 100 to cause an open portion of an antenna 150 to close an open switch on the antenna 150 creating a closed circuit for the antenna 150 to activate the card 100. In another case, the user inserts a key (200, 300) into a slot 152 in the card to cause an open circuit to be a closed circuit for the antenna 150 to activate the card 100. In yet another case, the user presses two conductive fobs 180 on both sides of an open antenna circuit to create a closed circuit for the antenna 150 to activate the card 100. In another case, the user presses a capacitive touch sensor 170 on the card, which causes firmware 130 to move the card from a non-data transmitting state to a data transmitting state.

At 730, the card 100 transmits card data residing within the card 100 for a transaction with a card reader 610 responsive to the user-controlled activation at 720. At 740, the firmware 130 enables a contactless payment at the card reader 610 for the transaction based on transmitting of the card data from card 100 to card reader 610 during the transaction.

In an embodiment, at 750, the card is deactivated in several scenarios. In a first scenario, a user’s removal of pressing on contact portions 160 or removal of a key (200, 300) cause the antenna 150 to move from a closed circuit to an open circuit. In a second scenario, the user’s removal of two conductive fobs 180 from both sides of the card 100 causes the antenna 150 to move from a closed circuit to an open circuit. In a third scenario, the firmware 130, after activating the card 100 for card data transmission based on a user touch of a capacitive touch sensor 170 on card 100, sets a timer upon the user’s touch and after a configured elapsed period of time from the user-controlled activation moves the card to a non-data transmitting state.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A contactless card, comprising:
a system on chip (SoC);
an antenna circuit coupled to the SoC; and
a selective activation control configured to maintain the antenna circuit in a disabled state by default and enable the antenna circuit in response to user activation.

2. The contactless card of claim 1, wherein the selective activation control comprises a switch integrated within a card structure that creates an open circuit in the antenna circuit when not activated.

3. The contactless card of claim 2, wherein the switch is configured to close the antenna circuit in response to applied pressure at designated edges of the contactless card.

4. The contactless card of claim 1, wherein the selective activation control comprises a removable key component configured to be inserted into the contactless card to complete the antenna circuit.

5. The contactless card of claim 4 wherein the removable key component comprises conductive material that bridges a gap in the antenna circuit when inserted.

6. The contactless card of claim 1, further comprising:
a microcontroller within the SoC;
firmware executed by the microcontroller; and
a capacitive touch sensor coupled to the SoC.

7. The contactless card of claim 6, wherein the firmware is configured to:
detect activation of the capacitive touch sensor;
enable data transmission for a predetermined time period; and
disable data transmission after expiration of the predetermined time period.

8. The contactless card of claim 1, wherein the selective activation control comprises conductive fobs configured to be placed on opposite sides of a break in the antenna circuit to complete the antenna circuit.

9. The contactless card of claim 1, wherein the selective activation control comprises a removable key base configured to be placed over or to receive a side of the contactless card to complete the antenna circuit.

10. The contactless card of claim 1, wherein the antenna circuit comprises multiple connection points configured for selective completion through user activation.

11. The contactless card of claim 1, wherein the SoC includes an antenna interface configured to control data transmission capabilities of the contactless card.

12. A system, comprising:
a payment card including:
a system on chip (SoC);
an antenna circuit coupled to the SoC;
a microcontroller within the SoC; and
a selective activation control configured to control completion of the antenna circuit; and
a contactless card reader comprising a wireless transceiver configured to wirelessly receive card data from the payment card during a payment transaction.

13. The system of claim 12, further comprising:
firmware stored in non-transitory computer-readable storage medium and executed by the microcontroller; and
a capacitive touch sensor coupled to the SoC.

14. The system of claim 13, wherein the firmware is configured to:
detect user input through the capacitive touch sensor;
enable card data transmission from the payment card to the contactless card reader in response to the user input; and
automatically disable data transmission after a predetermined time period.

15. The system of claim 12, wherein the selective activation control comprises conductive elements configured to bridge a gap in the antenna circuit.

16. The system of claim 12, further comprising a specialized removable key base configured to complete the antenna circuit when the payment card is inserted.

17. The system of claim 12, wherein the SoC includes an antenna interface configured to control data transmission capabilities of the payment card.

18. The system of claim 12, wherein the selective activation control comprises a removable key configured to be stored separately from the payment card and inserted into the payment card to complete the antenna circuit.

19. A method, comprising:
maintaining a contactless card in a disabled state by default;
detecting a user-controlled activation of the contactless card;
transmitting, by the contactless card, card data responsive to the user-controlled activation; and
enabling a contactless payment at a card reader for a transaction based on transmitting of the card data from the contactless card to the card reader.

20. The method of claim 19, further comprising:
detecting removal of the user-controlled activation or detecting an elapsed period of time since the user-controlled activation; and
disabling the contactless card to a non-data transmitting state.
